(19) United States
(12) Patent Application Publication
(10) Pub. No.: US 2025/0091944 A1
(43) Pub. Date: Mar. 20, 2025

(54) Pultruded GFRP Reinforcing Bars, Dowels and Profiles with Carbon Nanotubes

(71) Applicant: UNM Rainforest Innovations, Albuquerque, NM (US)

(72) Inventors: Mahmoud Reda Taha, Albuquerque, NM (US); Rahulreddy Chennareddy, Albuquerque, NM (US); Amr H. Riad, Cairo (EG)

(73) Assignee: UNM Rainforest Innovations, Albuquerque, NM (US)

(21) Appl. No.: 18/966,074

(22) Filed: Dec. 2, 2024

Related U.S. Application Data
(63) Continuation of application No. 16/760,392, filed on Apr. 29, 2020, now abandoned.
(60) Provisional application No. 62/580,627, filed on Nov. 2, 2017.

(51) Int. Cl. C04B 18/02; C08J 5/04; C08K 3/04; C08K 9/04; C08K 13/06; E01D 19/12; E04C 5/07

(52) U.S. Cl. CPC C04B 18/022; C08J 5/043; C08K 3/041; C08K 9/04; C08K 13/06; E04C 5/073; C08J 2333/04; C08J 2367/00; C08K 2201/011; E01D 19/125

(57) ABSTRACT

A glass fiber reinforced polymer reinforcing structure comprised of glass fibers mixed with one or more polymers. Incorporated in the polymer are a hybrid mix of pristine multi-walled carbon nanotubes at 0.0-4.0 wt % of the polymer and multi-walled carbon nanotubes functionalized with carboxylic group at 0.0-2.0 wt % of the polymer. The above mixture is pultruded to produce GFRP reinforcing bars, dowels or structural profiles.

### RELATED APPLICATIONS

This application is a continuation of Ser. No. 16/760,392 filed on Apr. 29, 2020, which is a U.S. National Phase of PCT/US2018/059015 filed on 2 Nov. 2018, which claims the benefit of U.S. Provisional Application No. 62/580,627 filed on 2 Nov. 2017, all of which are herein incorporated by reference.

### STATEMENT REGARDING FEDERALLY SPONSORED RESEARCH & DEVELOPMENT

This invention was made with government support under 69A3551747106 awarded by the U.S. Department of Transportation. The government has certain rights in the invention.

### BACKGROUND OF THE INVENTION

Corrosion caused by the use of deicing salts and severe climate conditions is responsible for numerous structurally deficient bridge decks. Glass Fiber Reinforced Polymer (GFRP) reinforcing bars and dowels have become an acceptable alternative for typical steel bars and dowels when corrosion is a major problem. Presently, GFRP is commercially available at a relatively low price in different configurations like uni- and bi-directional laminates, reinforcing bars, dowels and pultruded structural sections. GFRP reinforcing bars and dowels are used for both new construction and for the strengthening of existing structures. However, the literature shows that GFRP exhibits premature tension failure due to the weak interfacial bond between the glass fibers and the polymer matrix. This weak interfacial bond results in a number of other potential limitations of GFRP including limited fatigue strength and relatively low creep rupture stress. Such mechanical limitations result in design code provisions limiting the maximum stress in GFRP bars in structural design. More importantly shear strength of GFRP is relatively low compared with Carbon fiber reinforced polymer (CFRP) and steel bars. This limits the possible use of GFRP as dowels for bridge decks or slabs on grades and in shear critical regions. Finally, all GFRP frame structures utilize pultruded GFRP sections and profiles for their lightweight, easy construction and corrosion resistance. Structural design using these sections is typically governed by the limited shear strength of GFRP profiles at structural joint. Limited shear strength of GFRP thus represents a major limitation for its practical use in concrete and other structures.

Carbon nanotubes (CNTs) are the strongest materials available today. With appreciable strength, low cost and easy industrial availability, multi-walled carbon nanotubes (MWCNTs) in small quantities are used to improve the strength and stiffness of the polymer composite materials. When MWCNTs are dispersed in a polymer matrix, they act as reinforcement fibers at the microscale. However, the nano scale diameter of MWCNTs, allows them to interfere with the polymerization of the polymers altering the polymer matrix. Furthermore, MWCNTs can be engineered by surface functionalization using active chemical groups to form covalent bonds with the matrix.

### BRIEF SUMMARY OF THE INVENTION

In one embodiment, the present invention uses in GRFP ester-based (e.g. vinyl ester, poly ester) polymer nano composite by incorporating hybrid mixture of pristine multi-walled carbon nanotubes (P-MWCNTs) at 0.0-4.0 wt. % of the ester resin and MWCNTs functionalized with carboxylic group (COOH-MWCNTs) at 0.0-2.0 wt. % of the ester resin. Incorporating hybrid mix of MWCNTs into the ester polymer resin improves the bond between the polymer matrix and the silane sizing on the surface of glass fibers. This improves the mechanical properties, specifically shear strength, creep rupture strength and fatigue strength of GFRP materials including reinforcing bars, reinforcing dowels and GFRP profiles.

In one embodiment, the present invention uses in GRFP an ester polymer nano composite by incorporating hybrid mix of pristine multi-walled carbon nanotubes (P-MWCNTs) at 0.0-4.0 wt. % of the resin and MWCNTs functionalized with carboxylic group (COOH-MWCNTs) at 0.0-2.0 wt. % of the resin. Incorporating MWCNTs into the polymer resin improves the bond between the polymer matrix and the silane sizing on the surface of glass fibers. It also provides crack arresting mechanisms for microcracking in the matrix and interface. This improves the mechanical properties, specifically the shear and creep strengths of GFRP materials including reinforcing bars, dowels and profiles and structures.

In other embodiments, the present invention concerns glass fiber reinforced polymers (GFRP) reinforcing bars, dowels and profiles. Pristine multi-walled carbon nanotubes (P-MWCNTs) and Multi-walled carbon nanotubes (MWCNTs) with carboxyl functional group (COOH-MWCNTs) may be dispersed into the resin to produce GFRP bars. The GFRP bars may be produced by pultrusion. Direct tension and short beam shear tests confirm that using hybrid mix of MWCNTs improve the mechanical behavior of GFRP reinforcing bars by 20% and 111% for the tensile and shear strength respectively.

In other embodiments, the present invention concerns GFRP reinforcing bars, dowels and profiles that have an absence of the typical broom failure observed in neat GFRP bars and dowels when incorporating MWCNTs. As a result, the present invention, by using nano-modification of GFRP using MWCNTs overcomes many of the current limitations of GFRP reinforcing bars, dowels and profiles/sections.

In other embodiments, the present invention concerns GFRP reinforcing bars and dowels and other profiles including hybrid mix of MWCNTs that improve the tensile strength of pultruded GFRP bars, dowels and profiles by up to 20% and the shear strength by 111% with an evident change in GFRP failure mode.

In yet other embodiments, incorporating another hybrid mix of P-MWCNTs and COOH-MWCNTs improves shear strength of GFRP reinforcing structures by 53% and has limited to no effect on the tensile strength and the failure mode. Improvement in shear strength is attributed to a chemical reaction of MWCNTs with the ester matrix producing an improved bond with the silane sizing on glass fibers. Shear strength improvements with MWCNTs is attributed to the ability of MWCNTs to work as microscale fiber reinforcement preventing microcrack propagation and improving shear transfer within the GFRP bars, dowels and profiles. The significant improvement in shear strength of using hybrid mix of MWCNTs is specifically useful for GFRP reinforced elements specifically when used as reinforcing bars or dowels in bridge deck applications.

In other embodiments, the present invention provides a broom resistant glass fiber reinforced polymer reinforcing structure that is an elongated structure comprised of glass fibers mixed with one or more polymers, a plurality of pristine multi-walled carbon nanotubes at 0.0-4.0 wt. % of the polymer, and multi-walled carbon nanotubes functionalized with carboxylic group at 0.0-2.0 wt. % of the polymer.

In other embodiments, the present invention provides a reinforced concrete structure using a plurality of broom resistant GFRP reinforcing bars embedded in the concrete structure. The broom resistant GFRP reinforcing bars are made from glass fibers mixed with one or more polymers; a plurality of pristine multi-walled carbon nanotubes at 0.0-4.0 wt. % of said polymer are incorporated in said polymer; and multi-walled carbon nanotubes functionalized with carboxylic group at 0.0-2.0 wt. % of said polymer are incorporated in said polymer.

In other embodiments, the present invention provides a method of reinforcing a concrete structure by embedding a plurality of broom resistant GFRP reinforcing bars, dowels or elongated structures in the concrete structure. The broom resistant GFRP reinforcing bars, dowels or elongated structures are made by pultruding glass fibers mixed with one or more polymers, a plurality of pristine multi-walled carbon nanotubes at 0.0-4.0 wt. % of said polymer are incorporated in said polymer and multi-walled carbon nanotubes functionalized with carboxylic group at 0.0-2.0 wt. % of said polymer are incorporated in said polymer. In other aspects, the mixture may be comprised of a plurality of pristine multi-walled carbon nanotubes at 0.0-4.0 wt. % of the polymer, and multi-walled carbon nanotubes functionalized with carboxylic group at 0.0-2.0 wt. % of the polymer.

In other embodiments, the present invention provides a method of making a broom resistant GFRP reinforcing elongated structures for reinforcing a concrete structure by combining glass fibers with one or more polymers, a plurality of pristine multi-walled carbon nanotubes at 0.0-4.0 wt. % of said polymer, and multi-walled carbon nanotubes functionalized with carboxylic group at 0.0-2.0 wt. % of said polymer to create a matrix. In other aspects, a plurality of pristine multi-walled carbon nanotubes at 2.0 wt. % of the polymer, and multi-walled carbon nanotubes functionalized with carboxylic group at 0.5 wt. % of the polymer may be used to create the matrix. The matrix is mixed and pultruded through a die.

In other embodiments, the present invention provides glass fiber reinforced polymer reinforcing structures as well as reinforcing dowels, plates, angles, and I-beams.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIGS. 1A and 1B: Test setup; (1A) Direct tension; (1B) Shear test of GFRP bars incorporating MWCNTs.

FIG. 2: Stress-strain behavior of GFRP bars Neat and with MWCNTs under uniaxial tension.

FIGS. 3A, 3B and 3C: Tension failure modes for GFRP bars with MWCNTs.

FIG. 4: Short beam shear strength for GFRP bars incorporating MWCNTs.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In one embodiment, the present invention concerns GFRP reinforcing structures including, but not limited to, elongated structures such as bars and dowels. In one preferred embodiment, the GFRP structures may be made from pultruded glass fiber spools.

An ester-based resin (vinyl ester or polyester) with Methyl Ethyl Ketone Peroxide may be used as the curing agent in the polymeric matrix in fabricating the GFRP pultruded structures. P-MWCNTs and/or COOH-MWCNTs or a mixture of them may also be used. The MWCNTs preferably have an inner diameter of 5-10 nm and outer diameter of 20-30 nm with bulk density of 0.21 gm/cm³ and 110 m²/g specific surface area. For dispersing MWCNTs in the ester resin, ultrasonication at 40° C. for 60 min followed by mechanical stirring at 800 rpm for 120 min at 80° C. may be used. After the MWCNTs-ester nanocomposite cools to room temperature, it may then be pultruded into GFRP reinforcing elongated structures such as dowels, bars or profiles.

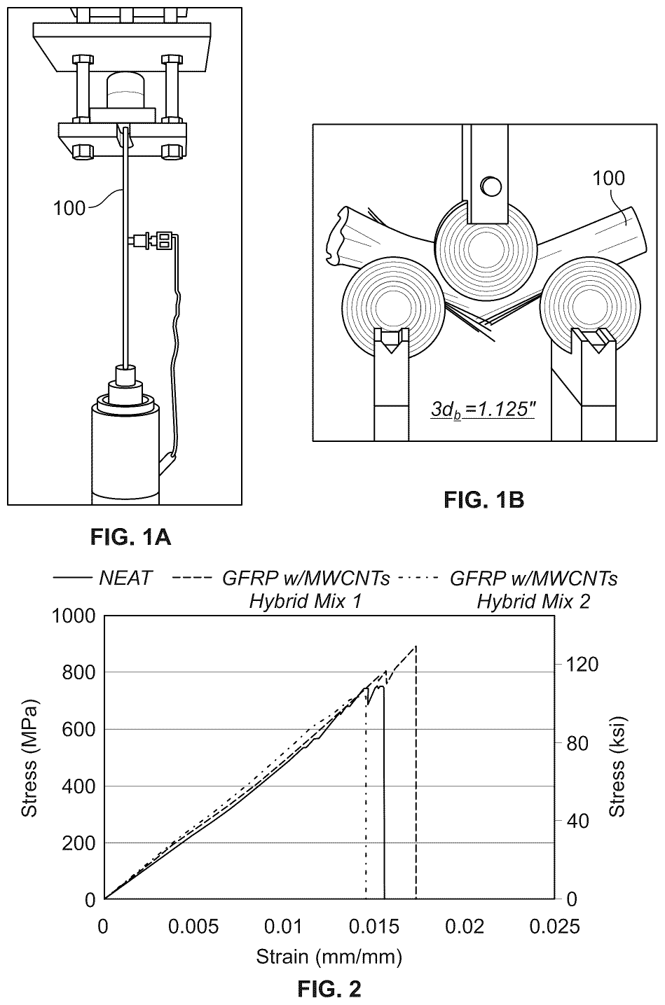

For the pultrusion process of the embodiment concerning a GFRP bar, a circular die with hole(s) with heating plates may be used to maintain a constant temperature inside the die to cure the GFRP. Other diameters and or shapes (profiles) might be produced using pultrusion technology. A constant pull speed is used with a speed-controlled gear motor. Post-fabrication, the GFRP bars/dowels are cured at 130° C. for 2 hrs (or other temperatures and time periods) to ensure complete polymerization of the polymer matrix. GFRP bars with constant fiber volume fraction (about 55%) with three example hybrid MWCNTs concentrations were fabricated as example. The bars were mechanically tested for each type under uniaxial tension following ASTM D7205/D7205M and 5 bars for each type under longitudinal shear test using short beam bend test following ASTM D4475 [10,11]. FIG. 1(a) and FIG. 1(b) presents the experimental protocol for tensile and short beam shear test for bar 100. The data for the two tests was acquired at 10 Hz interval. Fiber volume fraction of the GFRP bars with and without MWCNTs was determined using ASTM-D3171. In other aspects, a plurality of pristine multi-walled carbon nanotubes at 0.0-4.0 wt. % of the polymer, and multi-walled carbon nanotubes functionalized with carboxylic group at 0.0-2.0 wt. % of the polymer may be used to create a matrix.

The fiber volume fractions of the GFRP for Neat, hybrid mix 1 MWCNTs and hybrid mix 2 MWCNTs GFRP bars were 61.2%, 59.3% and 60.4% respectively. The results of the direct tension tests are presented in Table. 1. The stress-strain behavior of GFRP with and without MWCNTs is shown in FIG. 2. Tension test results indicate that an improvement in tensile strength by 20% was achieved compared with neat GFRP bars when functionalized COOH-MWCNTs were used. This improvement was proven to be statically significant with 95% confidence level using student t-test.

TABLE 1
Test results

| | Tensile | Tensile | Shear |
|---|---|---|---|
| Sample | Strength | Modulus | Strength |
| description | MPa | GPa | MPa |
| NEAT GFRP | 694 ± | 45.4 ± | 24.6 ± |
| | 71 | 0.29 | 1.0 |
| GFRP with | 832 ± | 45.5 ± | 49.6 ± |
| MWCNTs Hybrid | 42 | 1.66 | 2.4 |
| Mix 1 | | | |
| GFRP with | 708 ± | 46.8 ± | 37.8 ± |
| MWCNTs Hybrid | 18 | 0.28 | 2.1 |
| Mix 2 | | | |

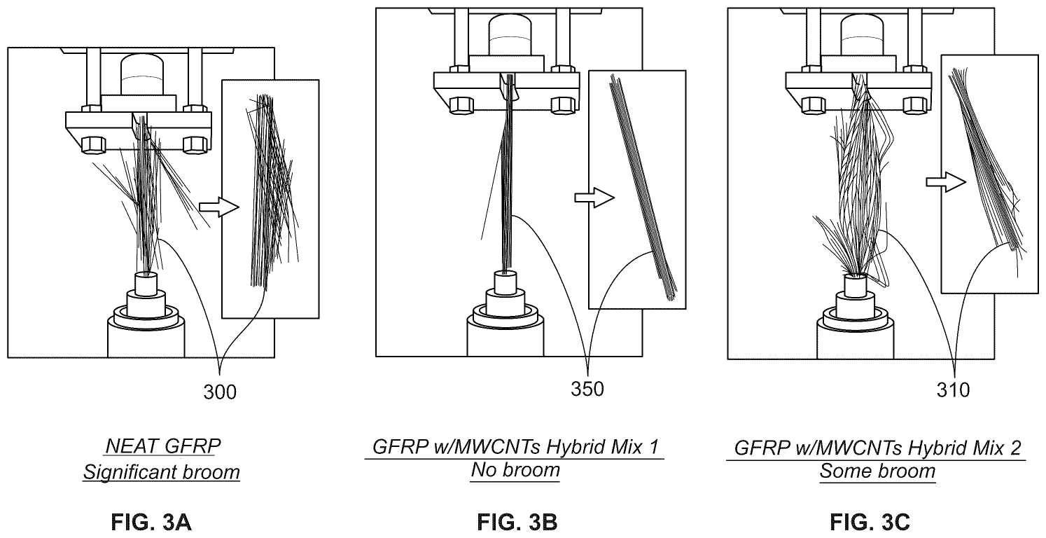

The stress-strain behavior of GFRP with MWCNTs showed a linear elastic behavior to failure with similar slopes for all the GFRP samples with and without MWCNTs. The strain at failure was higher for the samples with hybrid mix 1 MWCNTs as shown in FIG. 2. This increase in the strain at failure can be attributed to the improved interfacial bond between the silane sizing on the glass fibers and the COOH functionalization on the MWCNTs. However, GFRP incorporating hybrid mix 2 MWCNTs showed a negligible improvement in tensile strength and strain compared with neat GFRP. This negligible improvement might be attributed to the absence of functional groups in hybrid mix 2 to interfere with the polymerization and to improve the bond with glass fibers. Moreover, GFRP bars with hybrid mix 2 showed a similar stress-strain behavior to that of neat GFRP. More interestingly, the modes of failure in tension of GFRP bars incorporating MWCNTs are presented in FIG. 3. Unexpectedly, GFRP bar 350 with hybrid mix 1 MWCNTs showed almost no broom failure. This is the result of the ability of COOH-MWCNTs to improve the interfacial bond between glass fibers and ester matrix. This results in an increased tensile strength and prevents the typical broom effect that follows fibers debonding from the matrix. GFRP bar 310 incorporating hybrid mix 2 MWCNTs showed limited improvement in broom failure.

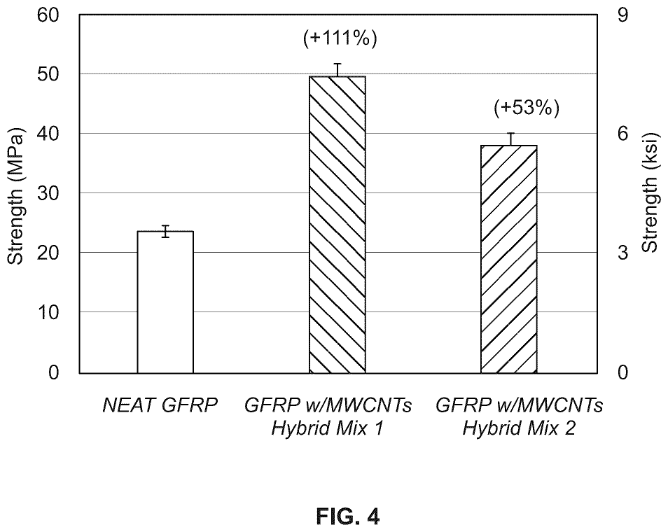

The short beam shear strength results are presented in Table 1. A significant improvement in shear strength by 111% and 53% was observed for GFRP incorporating hybrid mix 1 MWCNTs and hybrid mix 2 MWCNT respectively compared with neat GFRP. The results are summarized in a bar chart shown in FIG. 4. The shear strength improvements of GFRP bars with MWCNTs compared with neat GFRP were proved to be statistically significant with 95% confidence level using student t-test. As the shear strength of the GFRP is matrix dominant behavior, it is obvious that both P-MWCNTs and COOH-MWCNTs and their combinations can significantly improve the shear strength of GFRP bars, dowels and profiles. The improvement using COOH-MWCNTs can be explained by the chemical reaction of COOH-MWCNTs and the ester matrix.

The addition of P-MWCNTs improves the shear strength of GFRP bars. The high content of P-MWCNTs (0.0-4.0 wt. %) as part of the hybrid mix used in producing GFRP bars enables the P-MWCNTs to act as microscale reinforcement in the ester matrix and thus enables improved transfer of shear stresses within GFRP composite bar.

The above results indicate that using low concentration of COOH-MWCNTs as part of the hybrid mix well-dispersed in the ester matrix before pultrusion of GFRP bar 350, as opposed to a higher concentration, can produce the unexpected result of significantly improving the tensile strength by 20% and shear strength by 111%. This high improvement in shear strength of GFRP can have significant economic benefits in the design of GFRP bars and dowels widely used in bridge decks and slabs on grades. Economic analysis of the above addition showed the use of MWCNTs could result in increasing GFRP cost by 10-15%. This is a very limited cost increase compared to the significant improvement in shear strength above 100% of neat GFRP bars.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A glass fiber reinforced polymer reinforcing structure comprising:
an elongated structure;
said structure comprised of glass fibers mixed with one or more polymers;
a plurality of multi-walled carbon nanotubes at 0.1-4.0 wt. % of said one or more polymers are incorporated in said one or more polymers;
multi-walled carbon nanotubes functionalized with carboxylic group at 0.1-2.0 wt. % of said polymer are incorporated in said one or more polymers; and
wherein said multi-walled carbon nanotubes have an inner diameter of 5-10 nm and outer
diameter of 20-30 nm.

2. A glass fiber reinforced polymer reinforcing structure comprising:
an elongated structure;
said structure comprised of glass fibers mixed with one or more polymers;
a plurality of multi-walled carbon nanotubes at 0.1-4.0 wt. % of said one or more polymers are incorporated in said one or more polymers;
multi-walled carbon nanotubes functionalized with carboxylic group at 0.1-2.0 wt. % of said polymer are incorporated in said one or more polymers; and
wherein said multi-walled carbon nanotubes have a bulk density of 0.21 gm/cm and 110 m²/3 g specific surface area.

3. A glass fiber reinforced polymer reinforcing structure comprising:
an elongated structure;
said structure comprised of glass fibers mixed with one or more polymers;
a plurality of multi-walled carbon nanotubes at 0.1-4.0 wt. % of said one or more polymers are incorporated in said one or more polymers;
multi-walled carbon nanotubes functionalized with carboxylic group at 0.1-2.0 wt. % of said polymer are incorporated in said one or more polymers; and
wherein said multi-walled carbon nanotubes have an inner diameter of 5-10 nm and outer diameter of 20-30 nm with bulk density of 0.21 gm/cm′ and 10 m/g specific surface area.
